(19) United States
(12) Patent Application Publication
(10) Pub. No.: US 2009/0244379 A1
(43) Pub. Date: Oct. 1, 2009

(54) DISPLAY HAVING UNSHIELDED OSD AND METHOD FOR IMPLEMENTING UNSHIELDED OSD

(75) Inventor: Yuan-Hsi TSAI, Chung Ho City (TW)

Correspondence Address: Workman Nydegger;1000 Eagle Gate Tower, 60 East South Temple, Salt Lake City, UT, 84111, US

(73) Assignee: AMTRAN TECHNOLOGY CO., LTD, Chung Ho City (TW)

(21) Appl. No.: 12/190,727

(22) Filed: Aug. 13, 2008

(30) Foreign Application Priority Data
Mar. 26, 2008 (TW) 097110760

(51) Int. Cl. H04N 5/50

(52) U.S. Cl. 348/569; 348/E05.097

(57) ABSTRACT

A displayer having an unshielded on screen displayer (OSD) and a method for implementing the unshielded OSD are described. A microprocessor of the displayer having the unshielded OSD generates a plurality of first opaque items without a background color and a first background layer having a size the same as that of the first opaque items, and combines the first opaque items with the first background layer into a function menu. When a controller controls the first background layer to move around, the first background layer is overlapped with one of the first opaque items without the background color, and taken as an undercoat for the first opaque item, so as to highlight the information carried by the first opaque item. The first opaque item without the background color does not easily shield the screen image, so as to avoid shielding a viewable area of the screen.

### CROSS-REFERENCE TO RELATED APPLICATIONS

This non-provisional application claims priority under 35 U.S.C. §119(a) on Patent Application No(s). 097110760 filed in Taiwan, R.O.C. on Mar. 26, 2008 the entire contents of which are hereby incorporated by reference.

### BACKGROUND OF THE INVENTION

1. Field of the Invention

The present invention relates to a displayer and a method for implementing an on screen displayer (OSD), and more particularly to a displayer having an unshielded OSD and a method for implementing the unshielded OSD.

2. Related Art

On screen displayer (OSD) has been widely applied to screens (or displayers) of various electronic devices, for example, TV sets, mobile phones, notebook computers, or digital cameras. Generally, once a subscriber presses a menu control key, an OSD menu is displayed on the displayer device, which is provided for the subscriber to adjust various working indexes, including color, brightness, range of a displayed image, horizon/height of the displayed image, or to adjust function settings of the electronic device, such that the electric device achieves an optimal using state. However, the operation interface of the conventional OSD menu usually has a background or a frame, which may partly or completely shield the image on the displayer, and thus bring troubles in usage.

FIG. 1A is a schematic view of a conventional OSD. Referring to FIG. 1A, an OSD menu 110 has a plurality of control items 120 for adjusting the brightness, chroma, and horizon and height of the image displayed on the displayer, or even adjusting the volume of a speaker built in the displayer. The control items 120 are usually clustered together to form a single OSD menu 110, and give a background color to the OSD 110, which is convenient for the subscriber to identify. When a control item 120 is acknowledged and the control item 120 further has secondary control items 120, the secondary control items 120 are further clustered into the OSD menu 110. As seen from FIG. 1A, if there are too many secondary control items 120, the viewable area on the displayer is relatively reduced, or what's worse, the OSD menu even occupies the whole image on the displayer, which is inconvenient for the subscriber to operate. FIG. 1B is a schematic view of a conventional OSD. Referring to FIG. 1B, as for the OSD menu on some displayers, in order to overcome the defect of shielding the background image, the background transparency of the OSD menu 110 is particularly taken as a setting item, such that the subscriber sets the background transparency of the OSD menu 110 according to his/her own preference. Although the background transparency for the OSD menu 110 or control items 120 can be set, the background frame of the OSD menu 110 still interferes with the subscriber's operations. In addition, if the background transparency for the OSD menu 110 and control items 120 is blindly increased, a prompt content on the OSD menu 110 may be interfered by the content displayed on the image, and as a result, the subscriber cannot operate the OSD menu as desired.

### SUMMARY OF THE INVENTION

When the OSD menu of the displayer is operated, the OSD menu shields the displayed image, such that the viewable area on the screen is reduced, and as a result, it is inconvenient to adjust the image displayed on the screen or even causes interferences to the video signals when the subscriber watches the image on the screen. In view of the above defects, the present invention is directed to a displayer having an unshielded OSD, in which a function menu is formed by a plurality of first opaque items without a background color and a first background layer, and a controller controls the first background layer to move around.

The present invention is further directed to a method for implementing an unshielded OSD. Since the first opaque item without the background color does not affect the viewing of the image displayed on the screen, the plurality of first opaque items without the background color is combined into a function menu; then, the first background layer is overlapped with the first opaque item without the background color, such that the text and pattern information on the item is relatively clear. Merely a single first background layer appears on the image displayed on the screen, so as to avoid shielding the viewable area of the screen.

In order to achieve the above objective of the present invention, a displayer having an unshielded OSD provided in the present invention includes a screen, a microprocessor, a video processor (an OSD chip), and a controller. The screen of the displayer displays a video image according to a received video signal, for example, displays a received TV program or a film image thereon. The microprocessor further executes the following procedures: generating a plurality of first opaque items without a background color and a first background layer with a size the same as that of the first opaque items without the background color; then, overlapping the first background layer with one of the plurality of first opaque items without the background color; and then combining the first background layer with the first opaque item without the background color together to form a single function menu. The video processor receives the function menu from the microprocessor, and displays the function menu on the video image of the screen. The subscriber transmits a control signal through the controller, so as to adjust the displayed image, volume, and other setting parameters of the displayer by operating the function menu. The control signal includes: an acknowledgement signal, for instructing the microprocessor to execute a function indicated by an acknowledged first opaque item without the background color; and a function select signal, for moving the first background layer and displaying the first background layer with overlapping another first opaque item without the background color.

In the displayer having the unshielded OSD according to a preferred embodiment of the present invention, a display aspect of the first opaque items without the background color may be number, text, geometric pattern, or image stroke. In addition, a display color of the first opaque items without the background color may be changed according to an average chroma value of the video image.

In the displayer having the unshielded OSD according to a preferred embodiment of the present invention, the video processor further displays a sub-function menu. The sub-function menu is formed by a plurality of second opaque items without a background color and a first background layer, which is mainly used to provide auxiliary functions corresponding to the first opaque item without the background color selected in the function menu. In addition, the first background layer may be replaced by another second background layer, such that the subscriber can clearly identify the item on the sub-function menu to be acknowledged.

In order to achieve the other objective of the present invention, a method for implementing an unshielded OSD provided by the present invention includes the following steps.

First, after an “OSD displaying signal” transmitted from a controller is received, a plurality of first opaque items without a background color and a first background layer with a size the same as that of the first opaque items without the background color are generated.

Next, the first background layer is overlapped with any one of the first opaque items without the background color, and they are combined to a function menu. Then, the function menu is displayed on the video image. Finally, a function corresponding to a control signal is executed according to the control signal received from the controller.

If the control signal is a “function select signal”, the first background layer is moved and overlapping displayed on another first opaque item without the background color. If the control signal is an “acknowledgement signal”, the microprocessor is instructed to execute a function indicated by an acknowledged first opaque item without the background color.

In the method for implementing the unshielded OSD according to a preferred embodiment of the present invention, a displayer aspect of the first opaque items without the background color may be number, text, geometric pattern, or image stroke. In addition, a display color of the first opaque items without the background color is changed according to an average chroma value of the video image.

In the method for implementing the unshielded OSD according to a preferred embodiment of the present invention, the step of instructing the microprocessor to execute the function indicated by the acknowledged first opaque item without the background color further includes the following steps. Firstly, it is determined whether a sub-function menu corresponding to the acknowledged first opaque item without the background color exists or not. Next, merely the acknowledged first opaque item without the background color in the function menu is maintained. Then, another first background layer is overlapped with any one of the second opaque items without the background color in the sub-function menu, so that the function menu and the sub-function menu are displayed. The layers of the function menu and the sub-function menu are designed according to the function classification and practical requirements.

Based upon the above descriptions, in the displayer having the unshielded OSD and the method for implementing the OSD of the present invention, since the first opaque item without the background color does not shield the image displayed on the screen, the plurality of first opaque items without the background color are combined into a function menu, and then, the first background layer is overlapped with a single first opaque item without the background color, so as to clearly show the information carried by the first opaque item. The first opaque item without the background color does not easily shield the image displayed on the screen, so as to generate the OSD capable of avoiding shielding the viewable area of the screen.

### BRIEF DESCRIPTION OF THE DRAWINGS

The present invention will become more fully understood from the detailed description given herein below for illustration only, which thus is not limitative of the present invention, and wherein:

FIGS. 1A and 1B are schematic views of a conventional OSD;

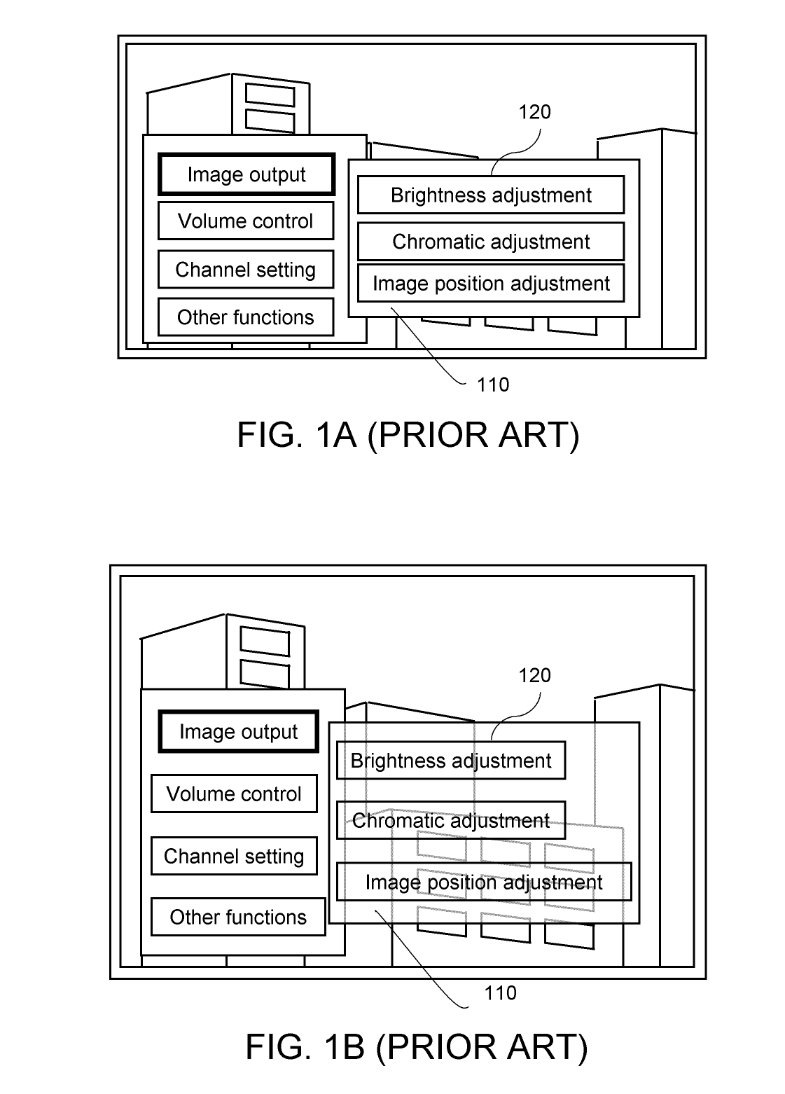

FIG. 2 is a schematic view of a multimedia device architecture having an unshielded OSD according to the present invention;

FIG. 3 is a flow chart of a method for implementing an unshielded OSD according to the present invention;

FIGS. 4A to 4C are schematic views of the unshielded OSD according to the present invention; and

FIG. 4D is a schematic view of moving a first background layer according to the present invention.

### DETAILED DESCRIPTION OF THE INVENTION

The objectives and method of the present invention are illustrated below in detail through the preferred embodiments. However, the concept of the present invention can be used in other scopes. The embodiments listed below are only intended to illustrate the objectives and method of the present invention, but not to limit the scope of the present invention.

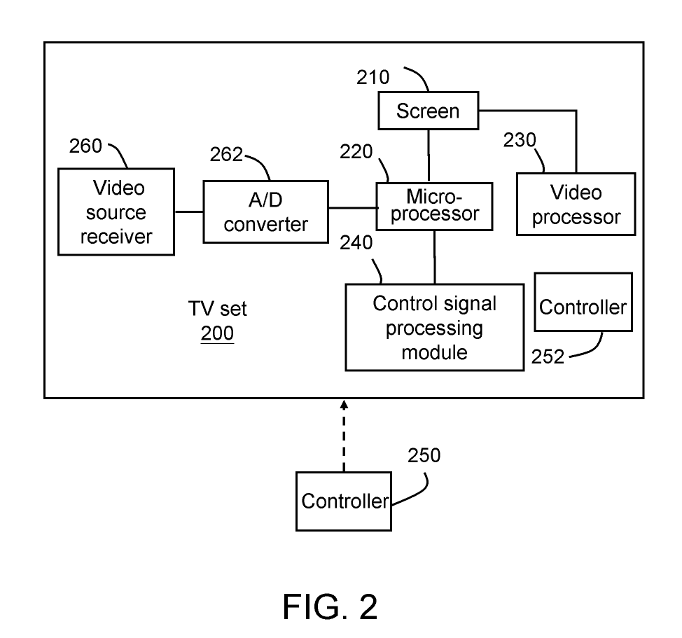

FIG. 2 is a schematic view of a multimedia device architecture having an unshielded OSD according to the present invention. Referring to FIG. 2, when receiving (and playing) a video signal, the displayer having the unshielded OSD in the preferred embodiment triggers to generate an OSD that avoids shielding the viewable area of the screen. The displayer having the unshielded OSD includes a screen 210, a microprocessor 220, a video processor 230, a control signal processing module 240, and controllers (250 and 252). The screen displays the video image according to the received video signal, and the video signal may come from an externally-connected audio-visual player.

In the preferred embodiment, the video signal comes from a video source receiver 260, and then is converted into a digital video signal by an analog-to-digital converter 262 (A/D converter) for being displayed (played), but the scope thereof is not limited herein. The microprocessor 220 is connected to the screen 210, the A/D converter 262, the video processor 230, and the control signal processing module 240, and executes the following procedures. Firstly, when the control signal processing module 240 receives an OSD displaying signal transmitted from the controller (250 or 252), the microprocessor 220 generates a plurality of first opaque items without a background color and a first background layer, and the size of the first background layer is the same as that of the first opaque items without the background color. Then, the first background layer is overlapped with any one of the first opaque items without the background color, and then they are combined into a single function menu. Once the microprocessor 220 generates the function menu, the video processor 230 receives the function menu and displays the function menu on the video image for being operated and used by the subscriber. The subscriber transmits a control signal through the controller (250 or 252), and meanwhile, the microprocessor 220 receives the control signal through the control signal processing module 240, and processes the received control signal. The control signal includes an acknowledgement signal, for instructing the microprocessor 220 to execute the function indicated by (corresponding to) the acknowledged first opaque item without the background color, and a function select signal, for moving the generated first background layer, and instructing the first background layer to be displayed with overlapping another first opaque item without the background color.

Accordingly, the display aspect of the first opaque item without the background color may be, for example, number, text, geometric pattern, or image stroke (stroked pattern obtained after performing an edge processing on the input image), and the display color of the first opaque items without the background color can be changed according to the average chroma value of the video image. For example, when the first opaque item without the background color is initialized, the received video signals are retrieved, and according to the retrieved chromas of the video signals, the average value is calculated, and then, the displayer color of the first opaque item without the background color is set according to the calculated chroma.

In addition, the video processor further displays a sub-function menu. The sub-function menu is subordinate to the particularly acknowledged first opaque item without the background color, and formed by a plurality of second opaque items without a background color and a first background layer. Here, the second opaque items without the background color are similar to the above mentioned first opaque items without the background color, and the display aspect of the second opaque items without the background color may be, for example, number, text, geometric pattern, or image stroke (stroked pattern obtained after performing the edge processing on the input image). In addition, the display color of the second opaque items without the background color may also be changed according to the average chroma value of the video image.

The plurality of second opaque items without the background color in the sub-function menu respectively indicates the auxiliary/detailed functions of the selected first opaque item without the background color. For example, once the first opaque item without the background color, “Volume control”, is acknowledged, the second opaque items without the background color pop up, including the functions of raising the volume, lowering the volume, and mute, and they are combined into the sub-function menu.

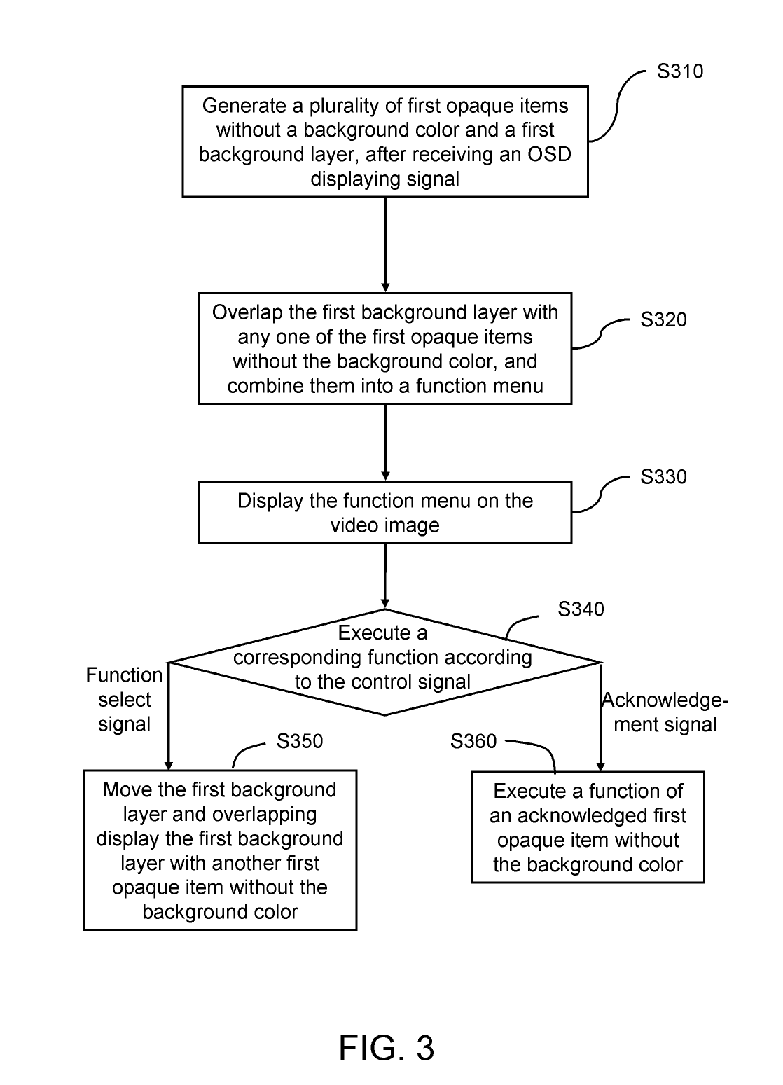

Additionally, the method for implementing the unshielded OSD of the present invention is illustrated according to another preferred embodiment. FIG. 3 is a flow chart of a method for implementing an unshielded OSD according to the present invention. In another preferred embodiment, the method for implementing the unshielded OSD of the present invention includes the following steps.

Firstly, after receiving the “OSD displaying signal” transmitted from the controller, a plurality of first opaque items without a background color and a first background layer with a size the same as that of the first opaque items without the background color are generated (Step S310). Next, the first background layer is overlapped with any one of the first opaque items without the background color, and meanwhile, they are combined into a function menu (Step S320). Then, the function menu is displayed on the video image (Step S330), and then, according to a control signal received from the controller, the function corresponding to the control signal is executed (Step S340). If the control signal is a “function select signal”, the first background layer is moved to overlapping display on another selected first opaque item without the background color (Step S350). If the control signal is an “acknowledgement signal”, the microprocessor is instructed to execute a function indicated by the acknowledged first opaque item without the background color (Step S360).

Similarly, the display aspect of the first opaque items without the background color may be, for example, number, text, geometric pattern, or image stroke, and the display color of the first opaque items without the background color may be changed according to the average chroma value of the video image.

When executing the function corresponding to the acknowledged first opaque item without the background color, the microprocessor specifically executes the following steps.

Firstly, it is determined whether a sub-function menu (i.e., an auxiliary function menu corresponding to the acknowledged first opaque item without the background color, which is formed by a plurality of second opaque items without a background color) corresponding to the acknowledged first opaque item without the background color exists or not. Next, merely the acknowledged first opaque item without the background color in the function menu is maintained, and the other unacknowledged first opaque items without the background color are not displayed. Then, another first background layer is generated, and the newly-added first background layer is overlapped with any one of the second opaque items without the background color in the sub-function menu. Then, after a new sub-function menu is formed, the function menu and the sub-function menu are displayed on the video mage of the screen (displayer). Definitely, the first background layer in the sub-function menu can also be replaced by a second background layer. In other words, the color and aspect of the first background layer in the function menu and the second background layer in the sub-function menu are not limited to being consistent with each other.

In addition, if one second opaque item without the background color in the sub-function menu is acknowledged, and it still has corresponding sub-function menu, another subordinate sub-function menu is further generated. The number of layers for the function menu and the sub-function menu can be designed according to the function classification and practical requirements, and the scope thereof is not restricted herein.

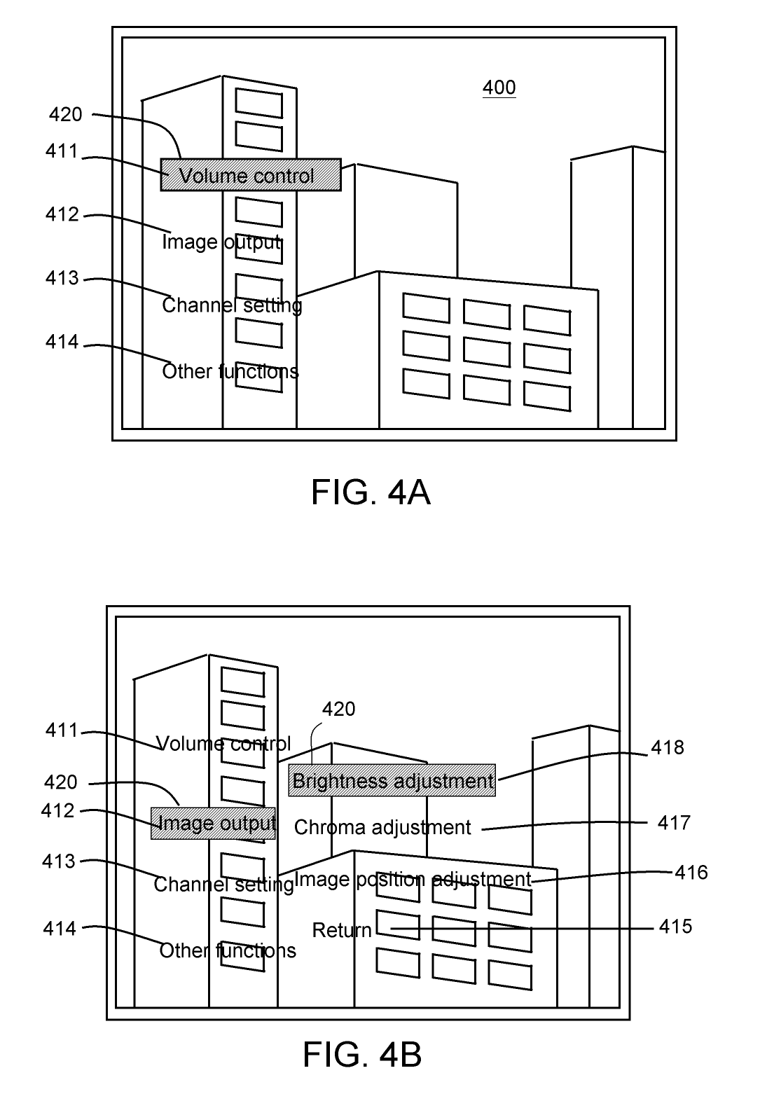

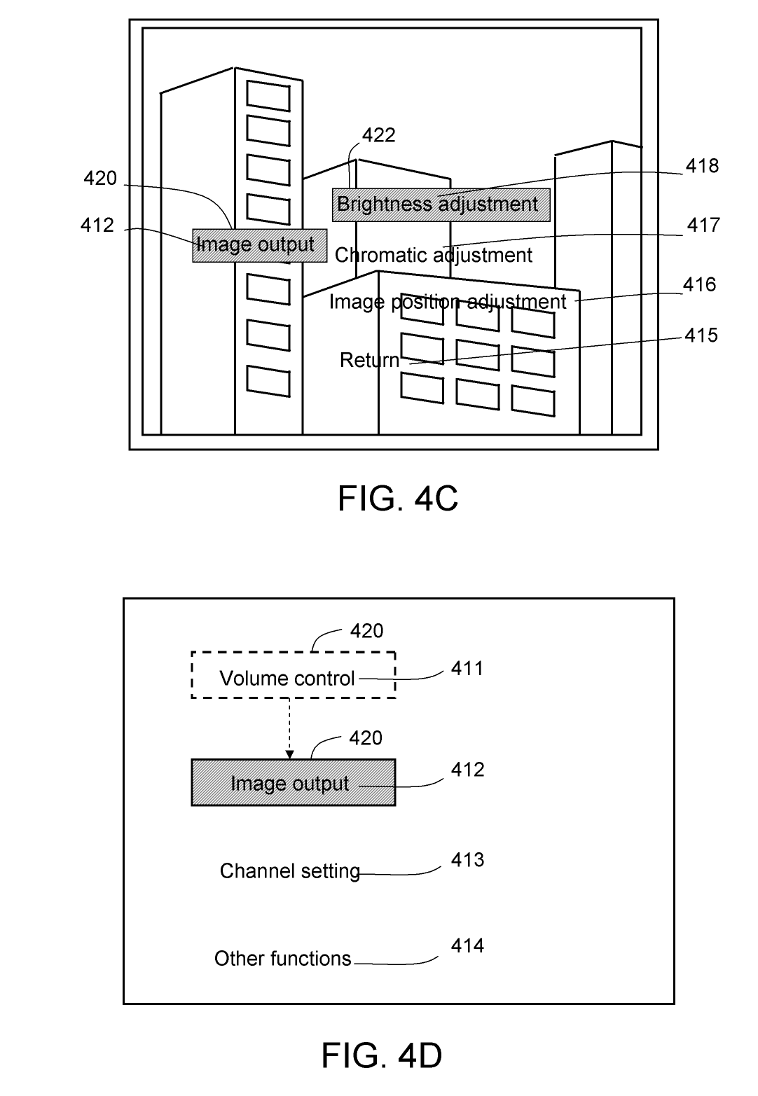

In order to demonstrate the present invention more clearly, the present invention is described below through the drawings. FIGS. 4A to 4C are schematic views of the unshielded OSD according to the present invention. Referring to FIG. 4A, when the function menu key (not shown) is pressed, the displayer having the unshielded OSD 400, as shown in FIG. 4A, is triggered to generate a function menu having the first opaque items without the background color (411 to 414). When the function menu is displayed, the first background layer 420 is overlapped with the first opaque item without the background color 411, such that the function message, “Volume control”, of the first opaque item without the background color 411 is easily identified. Referring to FIG. 4B, when the function is to be selected, the controller sends a “function select signal” to control the first background layer 420 to move downwards to another first opaque item without the background color 412, and to overlapping display the first background layer 420 and the first opaque item without the background color 412. Here, the sub-function menu corresponding to the first opaque item without the background color 412 is displayed, which is formed by a plurality of second opaque items without a background color (415 to 418) and a first background layer, and the newly-added first background layer 420 and the second opaque item without the background color 418 are displayed with overlapping.

In another embodiment, in order to prevent the video image displayed on the screen (displayer) from being shielded, the first opaque items without the background color, which are not needed, are further removed. Referring to FIGS. 4B and 4C, when the sub-function menu corresponding to the first opaque item without the background color 412 is displayed, the other first opaque items without the background color (411, 413, and 414 in FIG. 4B) in the original function menu are vanished and are not displayed in the video image (as shown in FIG. 4C), thereby increasing the scope of the viewable area. In addition, referring to FIG. 4C, in this embodiment, the second background layer 422 and one of the second opaque items without the background color (415-418) in the sub-function menu may also be overlapping displayed. The color and the aspect of the second background layer 422 are not limited to being consistent with that of the first background layer 420 in FIG. 4B, and the scope thereof is not limited here.

In order to demonstrate the relation between the background layer and the opaque item without the background color in the present invention in detail, it is illustrated through a drawing that does not include the TV program background (but merely the background layer and the opaque item without the background color are maintained). FIG. 4D is a schematic view of moving a first background layer according to the present invention. Referring to FIG. 4D, in this embodiment, the first background layer 420 is overlapped under the first opaque item without the background color 411, to serve as a undercoat for the first opaque item 411, so as to clearly display the pattern information of the first opaque item without the background color 411 (i.e., the function information “Volume control” of the first opaque item without the background color 411). When the first background layer 420 is moved to the first opaque item without the background color 412, the first opaque item without the background color 411 does not have the first background layer 420 as the undercoat, so that it is not easy to perceive the pattern information of the first opaque item without the background color 411. In contrast, the first opaque item without the background color 412 is overlapped with the first background layer 420, so the pattern information thereof is relatively distinct. In other words, the first opaque items without the background color (411 to 414) displayed on the video image do not disturb the subscribers when he/she views the video image, if they do not have the first background layer 420 as the undercoat. Through this principle, the unshielded OSD can be generated on the displayer, so as to solve the common shielding and interference problems caused by the current OSD.

What is claimed is:

1. A displayer having an unshielded on screen displayer (OSD), suitable for receiving a video signal and generating an OSD to avoid shielding a viewable area of a screen, comprising:
a screen, for displaying a video image according to the video signal;
a microprocessor, for executing the following procedures:
generating a plurality of first opaque items without a background color and a first background layer with a size the same as that of the first opaque items without the background color; and
overlapping the first background layer with one of the first opaque items without the background color, and combining the first opaque item without the background color with the first background layer into a function menu;
a video processor, for receiving the function menu from the microprocessor, and displaying the function menu on the video image; and
a controller, provided for a subscriber to transmit the following control signals:
sending an acknowledgement signal, for instructing the microprocessor to execute a function indicated by an acknowledged first opaque item without the background color; and
sending a function select signal, for moving the first background layer to display the first background layer with overlapping another first opaque item without the background color.

2. The displayer having an unshielded OSD according to claim 1, wherein a display aspect of the first opaque items without the background color is any one selected from a group consisting of number, text, geometric pattern, and image stroke.

3. The displayer having an unshielded OSD according to claim 1, wherein a display color of the first opaque items without the background color is changed according to an average chroma value of the video image.

4. The displayer having an unshielded OSD according to claim 1, wherein the video processor further displays a sub-function menu, and the sub-function menu is formed by combining a plurality of second opaque items without a background color with the first background layer and provides an auxiliary function corresponding to a first opaque item without the background color selected in the function menu.

5. The displayer having an unshielded OSD according to claim 1, wherein the video processor further displays a sub-function menu, and the sub-function menu is formed by combining a plurality of second opaque items without a background color with a second background layer and provides an auxiliary function corresponding to a first opaque item without the background color selected in the function menu.

6. A method for implementing an unshielded OSD, wherein the OSD is displayed on a video image of a displayer screen, the method comprising:
receiving an OSD displaying signal transmitted from a controller and then generating a plurality of first opaque items without a background color and a first background layer with a size the same as that of the first opaque items without the background color;
overlapping the first background layer with one of the first opaque items without the background color, and combining the first opaque item without the background color with the first background layer into a function menu;
displaying the function menu on the video image; and
executing a function corresponding to a control signal according to the received control signal:
moving the first background layer to be displayed by overlapping another first opaque item without the background color, if the control signal is a function select signal; and
instructing the microprocessor to execute a function indicated by an acknowledged first opaque item without the background color, if the control signal is an acknowledgement signal.

7. The method for implementing an unshielded OSD according to claim 6, wherein a display aspect of the first opaque items without the background color is any one selected from a group consisting of number, text, geometric pattern, and image stroke.

8. The method for implementing an unshielded OSD according to claim 6, wherein a display color of the first opaque items without the background color is changed according to an average chroma value of the video image.

9. The method for implementing an unshielded OSD according to claim 6, wherein the step of instructing the microprocessor to execute the function indicated by the acknowledged first opaque item without the background color further comprises:
determining whether a sub-function menu corresponding to the acknowledged first opaque item without the background color exists or not, wherein the sub-function menu is formed by a plurality of second opaque items without a background color;
merely maintaining the acknowledged first opaque item without the background color in the function menu; and
overlapping another first background layer with any one of the second opaque items without the background color in the sub-function menu, and displaying the function menu and the sub-function menu.

10. The method for implementing an unshielded OSD according to claim 6, wherein the step of instructing the microprocessor to execute the function indicated by the acknowledged first opaque item without the background color further comprises:
determining whether a sub-function menu corresponding to the acknowledged first opaque item without the background color exists or not, wherein the sub-function menu is formed by a plurality of second opaque items without a background color;
merely maintaining the acknowledged first opaque item without the background color in the function menu; and
overlapping a second background layer with any one of the second opaque items without the background color in the sub-function menu, and displaying the function menu and the sub-function menu.
